(19) United States
(12) Patent Application Publication
(10) Pub. No.: US 2008/0084830 A1
(43) Pub. Date: Apr. 10, 2008

(54) COMMUNCIATION APPARATUS, METHOD AND COMPUTER READABLE MEDIUM FOR ADJUSTING THE NUMBER OF CONNECTION IDENTIFICATION

(75) Inventors: Chih-Chiang Hsieh, Jen-Wu Township (TW); Shiann-Tsong Sheu, Taipei (TW); Heng-Iang Hsu, Taipei (TW); Lu-Wei Chen, Taipei City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/696,592

(22) Filed: Apr. 4, 2007

(30) Foreign Application Priority Data
Oct. 4, 2006 (TW) 095136903

(51) Int. Cl. H04J 1/16

(52) U.S. Cl. 370/252; 370/389

(57) ABSTRACT

A communication apparatus, a method, and a computer readable medium for adjusting the number of communication identifications (CID) are provided. The communication apparatus comprises a database, a quality of service (QoS) scheduler, and a CID adjustment engine. The database stores first service information and second service information which respectively comprise a corresponding CID. The QoS scheduler determines whether an operating load thereof reaches to a threshold value. If yes, the CID adjustment engine unifies the CIDs of the first service information and the second service information. The QoS scheduler schedules the first service information and the second service information in response to the unified CID.

This application claims the benefit of priority based on Taiwan Patent Application No. 095136903 filed on Oct. 4, 2006.

### CROSS-REFERENCES TO RELATED APPLICATIONS

Not applicable.

### BACKGROUND OF THE INVENTION

1. Field of the Invention

The present invention relates to a communication apparatus and a method for adjusting the number of communication identifications (CID); more specifically, relates to a communication apparatus and a method for adjusting the number of CIDs by unifying and/or splitting CIDs. The method can be implemented by a computer program which is stored in a computer readable medium.

2. Descriptions of the Related Art

With the rapid development of computer networks, services of various broadband contents have already become indispensable service elements. However, only the computer users in some areas of the world can obtain high-speed wired broadband services, such as digital subscribe line (DSL), cable broadband accessing service, etc. With the network telecommunication service providers' point of view, they expect to expand the availability range of their broadband network, whereas relevant construction cost for building wired network makes the providers hang back. Therefore, wireless broadband network technology becomes an important solution. Technologies of wireless network at present comprise wide area network (WAN), metropolitan area network (MAN), local area network (LAN), and personal area network (PAN). Each technology is for different communication distances.

IEEE 802.16, or WiMAX, is a new wireless transmission standard which is established initially for metropolitan area network to provide the “last mile” wireless broadband connection technology. After improved by the IEEE 802.16 develop personnel, now IEEE 802.16 also can support other market needs, such as various mobile and high-speed broadband applications. In contrast with IEEE 802.11 (Wi-Fi) and 3 G mobile communication technology, IEEE 802.16 has advantages of greater network broadband, lower building cost, better service quality, and better expansibility, etc. Furthermore, it can assist and expand a using mode of Wi-Fi hot points.

Because IEEE 802.16 protocol is a connection oriented protocol, quality of service (QoS) queues will be mapped to corresponding CIDs. Since CIDs carry resource configuration information of all IEEE 802.16 connections, and service flow identifications (SFIDs) corresponding to CIDs represent the amount of network resource approved by a base station when a user requests a service from the base station, CIDs are associated with complexity of scheduling QoS queues and equitableness of using network resource. Therefore, how a base station distributes CIDs to services is a very serious link in wireless communication. FIG. 1 is a schematic diagram illustrating a communication apparatus 1 operating under IEEE 802.16. The communication apparatus 1 comprises a packet classifier 101, a database 103, a payload header suppressor 105, a QoS queue register 107, and a QoS scheduler 109. When receiving a packet 100, the packet classifier 101 accesses the database 103 to find whether the database 103 stores a CID corresponding to the packet 100. If yes, it means that the packet 100 has been registered before. The packet classifier 101 retrieves service information for the packet 100 out from the database 103, and combines the retrieved service information with the packet 100 to generate a service datum 102. Then the service datum 102 is transmitted to the payload header suppressor 105. If the database 103 does not store the CID corresponding to the packet 100, it means that the packet 100 has not been registered yet. The packet classifier 101 requests the communication apparatus 1 to generate service information for the packet 100, assign a new CID for the packet 100, and stores the generated service information and the new CID into the database 103. Then the packet classifier 101 combines the generated service information with the packet 100 to generate the service datum 102. The service datum 102 is transmitted to the payload header suppressor 105 after that. After receiving the service datum 102, the payload header suppressor 105 suppresses repeated header content of the service datum 102 to reduce the size, and loads the service datum 102 with a suppressing rule. After that, the payload header suppressor 105 generates a QoS queue 104 according to the above conditions. The QoS queue register 107 receives and registers the QoS queue 104.

When packets keep entering the packet classifier 101, the above-mentioned process will be executed repeatedly. The QoS queues for new entering packets are transmitted to the QoS queue register 107 and are scheduled by the QoS scheduler 109. The larger the number of CIDs in the database 103 is, the more the QoS queues waiting for process are. In such circumstances, the QoS scheduler 109 needs a great quantity of resource to generate a schedule for the QoS queues. When the number of CIDs exceeds the limit that the QoS scheduler 109 can handle, or the predetermined number of CIDs runs out, the communication apparatus I cannot provide services any more. Therefore, it exists a serious problem needed to be solved.

### SUMMARY OF THE INVENTION

One objective of this invention is to provide a communication apparatus capable of adjusting the number of CIDs. The communication apparatus comprises a database, a QoS scheduler, and a CID adjustment engine. The database stores first service information and second service information, and the first service information and the second service information respectively comprises a corresponding CID. The QoS scheduler determines whether an operating load of the QoS scheduler reaches to a threshold value. The CID adjustment engine unifies the CIDs of the first service information and the second service information if the operating load reaches to the threshold value. The QoS scheduler schedules the first service information and the second service information in response to the unified CID. Another objective of this invention is to provide a method for adjusting the number of CIDs in a communication apparatus. The communication apparatus comprises a database storing first service information and second service information, and the first service information and the second service information respectively comprises a corresponding CID. The method comprises the following steps: determining whether an operating load of the communication apparatus reaches to a threshold value; and unifying the CIDs of the first service information and the second service information if the operating load reaches to the threshold value. The first service information and the second service information is scheduled in response to the unified CID.

Another object of this invention is to provide a computer readable medium storing a computer program for a communication apparatus to execute a method for adjusting the number of CIDs. The communication apparatus comprises a database which stores first service information and second service information, and the first service information and the second service information respectively comprises a corresponding CID. The method comprises the following steps: determining whether an operating load of the communication apparatus reaches to a threshold value; unifying the CIDs of the first service information and the second service information if the operating load reaches to the threshold value, and updating the CIDs of the first service information and the second service information in the database. The first service information and the second service information is scheduled in response to the unified CID.

Another objective of this invention is to provide a communication apparatus capable of adjusting the number of CIDs. The communication apparatus comprises a database, a QoS scheduler, and a CID adjustment engine. The database stores first service information and second service information, and the first service information and the second service information corresponds to an unified CID. The QoS scheduler determines whether an operating load of the QoS scheduler goes below a threshold value. The CID adjustment engine splits the unified CID into two split CIDs respectively corresponding to the first service information and the second service information if the operating load goes below the threshold value. The QoS scheduler schedules the first service information and the second service information in response to the split CDs.

Another objective of this invention is to provide a method for adjusting the number of CIDs in a communication apparatus. The communication apparatus comprises a database storing first service information and second service information, and the first service information and the second service information corresponds to an unified CID. The method comprises the following steps: determining whether an operating load of the communication apparatus goes below a threshold value; splitting the unified CID into two split CIDs respectively corresponding to the first service information and the second service information if the operating load goes below the threshold value; and scheduling the first service information and the second service information in response to the split CIDs.

Another object of this invention is to provide a computer readable medium storing a computer program for a communication apparatus to execute a method for adjusting the number of CIDs. The communication apparatus comprises a database which stores first service information and second service information, and the first service information and the second service information corresponds to an unified CID. The method comprises the following steps: determining whether an operating load of the communication apparatus goes below a threshold value; splitting the unified CID into two split CIDs respectively corresponding to the first service information and the second service information if the operating load goes below the threshold value; and updating the CIDs of the first information and the second service information in the database. The first service information and the second service information is scheduled in response to the split CIDs.

The present invention can identify whether a communication apparatus can increase the number of CIDs by determining the operating load of the communication apparatus. When the number of CIDs cannot be increased, some of the CIDs are unified to reduce the number of the same. After the number of the CIDs reduces, the load of scheduling will lower to avoid the situation that the communication apparatus is overloaded so that the efficiency of the communication apparatus is improved. Besides, the invention can determine whether the operating load of the communication apparatus lowers. If yes, CIDs are split to reduce the amount of transmitted data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a communication apparatus adapted to IEEE 802.16 standard of the prior art;

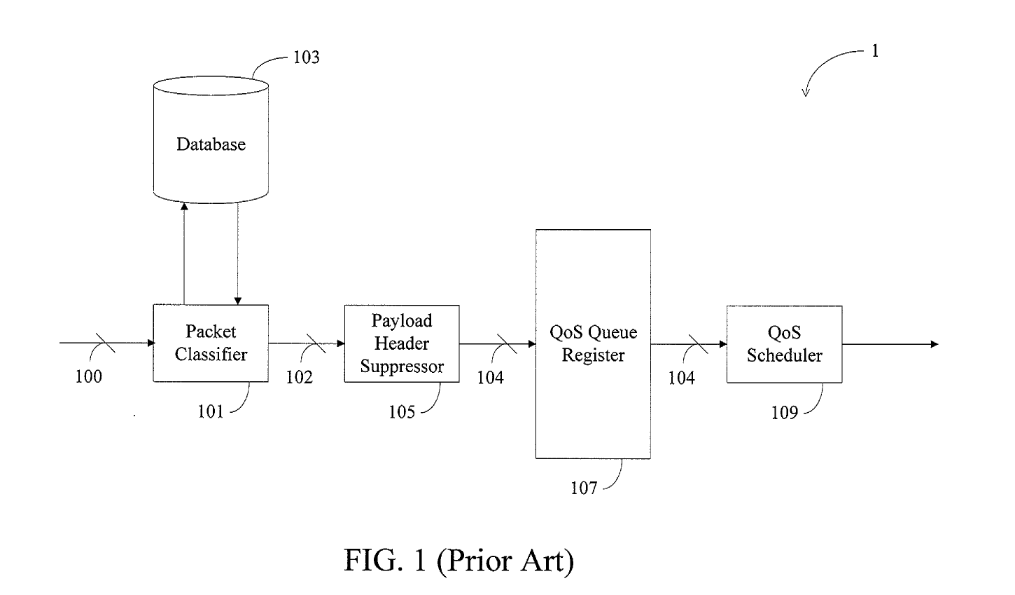

FIG. 2 is a schematic diagram illustrating a first embodiment of the present invention;

FIG. 3 is a schematic diagram illustrating a payload header of the first embodiment; and

FIG. 4 is a flow chart illustrating a second embodiment of the present invention.

### DESCRIPTION OF THE PREFERRED EMBODIMENT

In this specification, the term “in response to” is defined as “replying to” or “reacting to.” For example, “in response to a signal” means “replying to a signal” or “reacting to a signal” without necessity of direct signal reception.

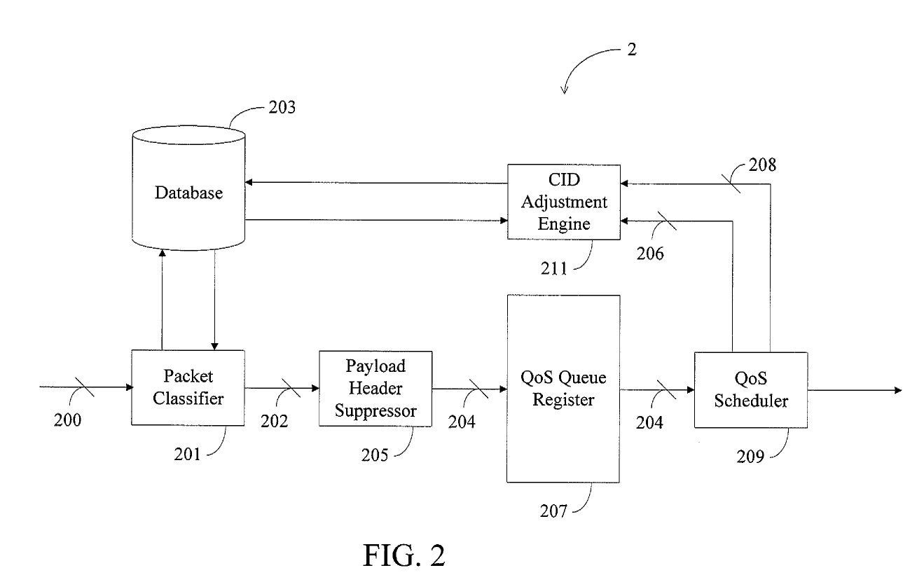

As shown in FIG. 2, a first embodiment of the present invention is a wireless communication apparatus 2 under IEEE 802.16 standard, which is capable of adjusting the number of connection CIDs. The wireless communication apparatus 2 comprises a packet classifier 201, a database 203, a payload header suppressor 205, a QoS queue register 207, a QoS scheduler 209, and a CID adjustment engine 211. The database 203 stores pieces of service information each of which has a corresponding CID. When the packet classifier 201 receives a packet 200, the packet classifier 201 accesses the database 203 to find whether the database 203 stores a CID corresponding to the packet 200.

If the database 203 stores the CID corresponding to the packet 200, the packet 200 can be scheduled for transmission by the QoS scheduler 209. If the database 203 does not store the CID corresponding to the packet 200, it means that there is no CID corresponding to the packet 200 in the database 203. The wireless communication apparatus 2 then generates service information related to the packet 200. The service information, recording a CID corresponding to the packet 200, is stored into the database 203. After that, the packet classifier 201 combines the generated service information with the packet 200 to generate a service datum 202, and the service datum 202 is transmitted to the payload header suppressor 205.

After suppressing the service datum 202, the payload header suppressor 205 generates a QoS queue 204. The QoS queue register 207 receives and registers the QoS queue 204. At an appropriate timing, the QoS queue register 207 transmits the QoS queue 204 to the QoS scheduler 209. The QoS scheduler 209 determines whether an operating load thereof reaches a threshold value. The QoS scheduler 209 transmits a first enable signal 206 to the CID adjustment engine 211 if the operating load reaches to the threshold value. The CID adjustment engine 211 unifies the CIDs of the pieces of the service information stored in the database 203 in response to the first enable signal 206.

The threshold value is the biggest number of QoS queues the wireless communication apparatus 2 can accept. For example, the threshold value may be 800, 900, or 1000 if the wireless communication apparatus 2 is a base station, or may be set 80, 90, or 120 if the wireless communication apparatus 2 is a mobile phone. Once the number of QoS queues reaches to the biggest number, the QoS scheduler 209 needs much hardware resource to schedule the QoS queues so that a processing speed becomes slow, or even the QoS queues fail to be processed. Therefore, some of the CIDs are unified to reduce the number of CIDs. Two pieces of service information whose CIDs have been unified will be regarded as one QoS queue.

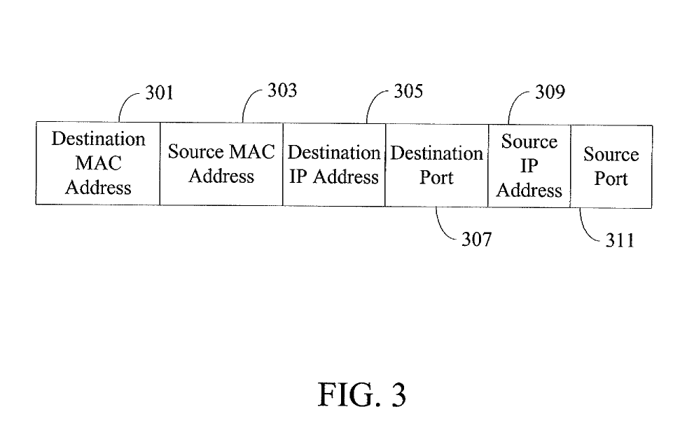

To unify CIDs, the CIDs in the database 203 being selected must have the same QoS class. IEEE 802.16 defines four kinds of QoS classes: UGS, RTPS, NRTPS, and Best Effort. The packets with different QoS classes have different payload header formats. As shown in FIG. 3, an example of a payload header consists of a destination MAC address 301 having six bytes, a source MAC address 303 having six bytes, a destination IP address 305 having four bytes, a destination port 307 having two bytes, a source IP address 309 having four bytes, and a source port 311 having two bytes.

In the pieces of service information having the same QoS class, the CIDs of two pieces service information which have most identical data in the headers are selected to be unified. The selection of most identical data in the headers makes the payload header suppressor 205 able to suppress the most data to reduce bandwidth needed during transmission.

The CID adjustment engine 211 has a table for listing the unifying priorities of the CIDs. An example of the table is shown as follows.

TABLE 1

| | Destination | Source | | | | |
|---|---|---|---|---|---|---|
| Unifying | MAC | MAC | Destination | Destination | Source IP | Source |
| Priority | Address | Address | IP Address | Port | Address | Port |
| 1 | ✓ | ✓ | ✓ | | ✓ | ✓ |
| 1 | ✓ | ✓ | ✓ | ✓ | ✓ | |
| 2 | ✓ | ✓ | ✓ | | ✓ | |
| 2 | ✓ | ✓ | ✓ | ✓ | | ✓ |
| 2 | ✓ | ✓ | | ✓ | ✓ | ✓ |
| 3 | ✓ | ✓ | | | ✓ | ✓ |
| 3 | ✓ | ✓ | ✓ | ✓ | | |
| 3 | ✓ | ✓ | ✓ | | | ✓ |
| 3 | | ✓ | ✓ | ✓ | ✓ | ✓ |
| 4 | ✓ | | ✓ | | ✓ | ✓ |
| 4 | | ✓ | ✓ | ✓ | ✓ | |
| 5 | | ✓ | | | ✓ | ✓ |

. . .
. . .

Lowest

The “✓” in fields of TABLE. 1 represents the same parts of payload headers, and the unifying priority field means the unifying priorities that the CID adjustment engine 211 chooses service information to unify CIDs thereof. The highest unifying priority means that data of payload headers corresponding to the service information have the most identical parts. For example, the first row of TABLE. 1 indicates that a different part of payload headers is only the destination port 307. Therefore, there are only two bytes different so that the unifying priority is the highest. There are only two bytes different in the second row as well so that the unifying priority is also the highest. If the unifying priorities are the same, it means the payload headers thereof have the same amounts of the identical data (bytes). The CID adjustment engine 211 can choose any CIDs whose priorities are the same to unify. The lowest unifying priority means that data of the payload headers are all different.

There is an example for illustration as follows. When unifying the CIDs, the CID adjustment engine 211 chooses the pieces of the service information having the same QoS class, such as the first service information (the corresponding CID is CID1), the second service information (the corresponding CID is CID2), and the third service information (the corresponding CID is CID3) all of which have the RTPS QoS class. Then the CID adjustment engine 211 chooses the service information whose headers have the most identical data in the three pieces of the service information. Assume the first service information and the second service information have the most identical data in the headers. The CID adjustment engine 211 unifies the CIDs of the first service information and the second service information into CID4. After the CIDs are unified, the CID adjustment engine 211 updates the CID4 in the database 203. When packets corresponding to the first service information and the second service information enter, the packet classifier 201 retrieves the CID4 from the database 203 so that the first service information and the second service information will be treated as one QoS queue but not two. Accordingly, the number of QoS queues is reduced.

The embodiment can continuous unifying until the number of QoS queues goes below the threshold value.

When the number of QoS queues goes below the threshold value, the QoS scheduler 209 determines whether a suppression rate that the payload header suppressor 205 suppresses headers is high enough. If not, it means that too much bandwidth is occupied during packet transmission. Under such circumstances, the QoS scheduler 209 transmits a second enable signal 208 to the CID adjustment engine 211. The CID adjustment engine 211 splits the unified CIDs of the service information in the database 203. More specifically, the CID adjustment engine 211 splits the CID of two pieces of service information whose headers have the least identical information. For example, the CID adjustment engine 211 splits the CID4 of the above first service information and the above second service information into CID5 and CID6, and updates the CID5 and CID6 in the database 203. When packets corresponding to the first service information and the second service information enter, the QoS scheduler 209 schedules the first service information and the second service information in response to the CID5 and the CID6, respectively.

Although FIG. 2 illustrates that the QoS scheduler 209 transmits the first enable signal 206 and the second enable signal 208 by two signal lines, the invention is not limited to this. More specifically, the QoS scheduler 209 can use a high level and a low level carried by a single line to present that the operating load reaches the threshold value and goes below the threshold value, respectively. Accordingly, the high level corresponds to the first enable signal 206, and the low level corresponds to the second enable signal 208.

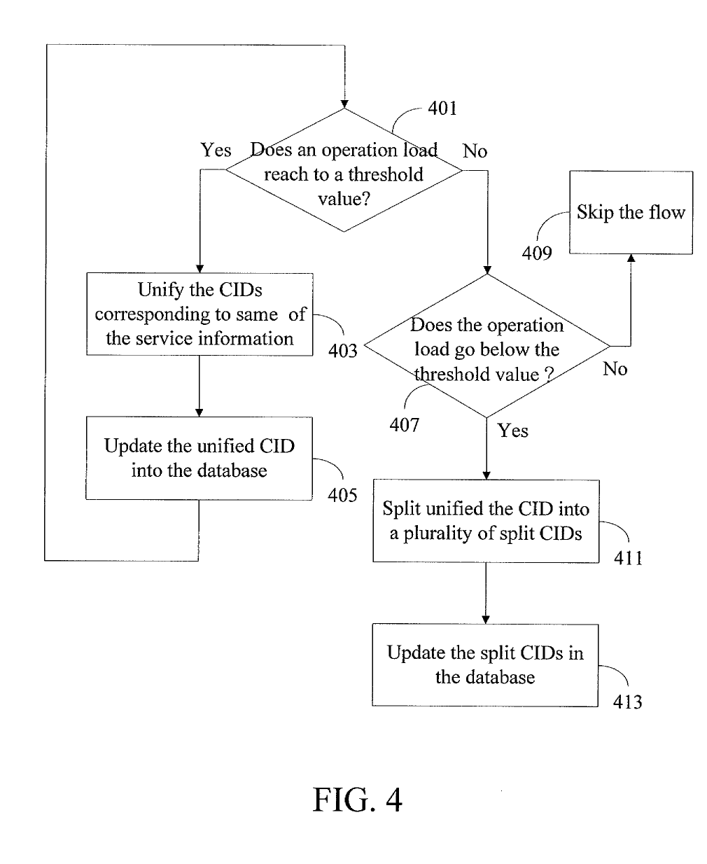

A second embodiment of the present invention is a method for adjusting the number of CIDs in a communication apparatus, such as the wireless communication apparatus 2. As shown in FIG. 4, the method is performed by an application program which is stored in a computer readable medium. After the communication apparatus receives a packet, step 401 is executed in which the application program comprises code for controlling the QoS scheduler to determine whether an operating load of the communication apparatus reaches a threshold value. If the operating load of the communication apparatus reaches the threshold value, step 403 is executed in which the application program comprises code for controlling the CID adjustment engine to unify the CIDs corresponding to some of the service information. Then, step 405 is executed in which the application program comprises code for controlling the CID adjustment engine to update the unified CID into the database. Then the method returns to step 401, the code controls the QoS scheduler to determine whether the operating load still reaches the threshold value. The QoS scheduler schedules the service information in response to the unified CIDs.

If the operating load of the communication apparatus does not reach the threshold value, step 407 is executed in which the application program comprises code for controlling the QoS scheduler to determine whether the operating load goes below the threshold value. If no, step 409 is executed in which the application program is skipped. If the operating load goes below the threshold value, step 411 is executed in which the application program comprises code for controlling the CID adjustment engine to split the unified CID into a plurality of split CIDs respectively corresponding to the unified service information. Then, step 413 is executed in which the application program comprises code for controlling the CID adjustment engine to update the split CIDs in the database. Finally, the QoS scheduler schedules the service information in response to the updated CIDs.

In addition to the steps shown in FIG. 4, the application program of the second embodiment has code able to execute all of the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

Accordingly, the present invention unifies CIDs to avoid scheduling overload when the operating load of the communication apparatus reaches to a threshold value. Furthermore, the present invention can spilt unified CIDs to reduce transmission bandwidth when the operating load goes below the threshold value. Therefore, the present invention can fully use an operation capability of the communication apparatus to avoid that the communication apparatus fail to provide service due to short of CIDs or overload.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication apparatus capable of adjusting the number of connection identifications (CID), comprising:
a database for storing first service information and second service information, the first service information and the second service information respectively comprising a corresponding CID;
a quality of service (QoS) scheduler for determining whether an operating load of the QoS scheduler reaches to a threshold value; and
a CID adjustment engine for unifying the CIDs of the first service information and the second service information if the operating load reaches to the threshold value;
wherein the QoS scheduler schedules the first service information and the second service information in response to the unified CID.

2. The communication apparatus as claimed in claim 1, wherein a class of the first service information and that of the second service information are the same.

3. The communication apparatus as claimed in claim 1, wherein the first service information and the second service information respectively correspond to a first packet and a second packet, the first packet and the second packet respectively comprise a header, and the first service information and the second service information are the service information, in all service information stored in the database, that has most identical data in the headers.

4. The communication apparatus as claimed in claim 1, wherein the CID adjustment engine splits the unified CID into two split CIDs respectively corresponding to the first service information and the second service information if the operating load goes below the threshold value, and the QoS scheduler schedules the first service information and the second service information in response to the split CIDs.

5. The communication apparatus as claimed in claim 1, further comprising a packet classifier, wherein when the packet classifier receives a packet, the QoS scheduler determines whether the operating load reaches to the threshold value in response to the receipt of the packet.

6. A method for adjusting the number of CIDs in a communication apparatus, the communication apparatus comprising a database for storing first service information and second service information, the first service information and the second service information respectively comprising a corresponding CID, the method comprising the steps of:
determining whether an operating load of the communication apparatus reaches to a threshold value; and
unifying the CIDs of the first service information and the second service information if the operating load reaches to the threshold value;
wherein the first service information and the second service information is scheduled in response to the unified CID.

7. The method as claimed in claim 6, wherein a class of the first service information and that of the second service information are the same.

8. The method as claimed in claim 6, wherein the first service information and the second service information respectively correspond to a first packet and a second packet, the first packet and the second packet respectively comprise a header, and the first service information and the second service information are the service information, in all service information stored in the database, that has most identical data in the headers.

9. The method as claimed in claim 6, further comprising the step of:
determining whether the operating load goes below the threshold value; and
splitting the unified CID into two split CIDs respectively corresponding to the first service information and the second service information if the operating load goes below the threshold value;
wherein the first service information and the second service information is scheduled in response to the split CIDs.

10. The method as claimed in claim 6, further comprising the step of:
receiving a packet;
wherein the determining step is executed in response to the receiving step.

11. A computer readable medium storing a computer program for a communication apparatus to execute a method for adjusting the number of CIDs, the communication apparatus comprising a database for storing first service information and second service information, the first service information and the second service information respectively comprising a corresponding CID, the method comprising the steps of:
determining whether an operating load of the communication apparatus reaches to a threshold value;
unifying the CIDs of the first service information and the second service information if the operating load reaches to the threshold value; and
updating the CIDs of the first service information and the second service information in the database;
wherein the first service information and the second service information is scheduled in response to the unified CID.

12. The computer readable medium as claimed in claim 11, wherein a class of the first service information and that of the second service information are the same.

13. The computer readable medium as claimed in claim 11, wherein the first service information and the second service information respectively correspond to a first packet and a second packet, the first packet and the second packet respectively comprise a header, and the first service information and the second service information are the service information, in all service information stored in the database, that has most identical data in the headers.

14. The computer readable medium as claimed in claim 11, wherein the method further comprises the step of:
determining whether the operating load goes below the threshold value;
splitting the unified CID into two split CIDs respectively corresponding to the first service information and the second service information if the operating load goes below the threshold value; and
updating the CIDs of the first service information and the second service information in the database;
wherein the first service information and the second service information is scheduled in response to the split CIDs.

15. The computer readable medium as claimed in claim 11, wherein the method further comprises the step of:
receiving a packet;
wherein the determining step is executed in response to the receiving step.

16. A communication apparatus capable of adjusting the number of CIDs comprising:
a database for storing first service information and second service information, the first service information and the second service information corresponding to an unified CID;
a QoS scheduler for determining whether an operating load of the QoS scheduler goes below a threshold value; and
a CID adjustment engine for splitting the unified CID into two split CIDs respectively corresponding to the first service information and the second service information if the operating load goes below the threshold value;
wherein the QoS scheduler schedules the first service information and the second service information in response to the split CIDs.

17. The communication apparatus as claimed in claim 16, further comprising a packet classifier, wherein when the packet classifier receives a packet, the QoS scheduler determines whether the operating load goes below the threshold value in response to the receipt of the packet.

18. A method for adjusting the number of CIDs in a communication apparatus, the communication apparatus comprising a database for storing first service information and second service information, the first service information and the second service information corresponding to an unified CID, the method comprising the steps of:
determining whether an operating load of the communication apparatus goes below a threshold value;
splitting the unified CID into two split CIDs respectively corresponding to the first service information and the second service information if the operating load goes below the threshold value; and
scheduling the first service information and the second service information in response to the split CIDs.

19. The method as claimed in claim 18, further comprising the step of:
receiving a packet;
wherein the determining step is executed in response to the receiving step.

20. A computer readable medium storing a computer program for a communication apparatus to execute a method for adjusting the number of CIDs, the communication apparatus comprising a database for storing first service information and second service information, the first service information and the second service information corresponding to an unified CID, the method comprising the steps of:
determining whether an operating load of the communication apparatus goes below a threshold value;
splitting the unified CID into two split CIDs respectively corresponding to the first service information and the second service information if the operating load goes below the threshold value; and
updating the CIDs of the first service information and the second service information in the database;
wherein the first service information and the second service information is scheduled in response to the split CIDs.

21. The computer readable medium as claimed in claim 20, wherein the method further comprises the step of:
receiving a packet;
wherein the determining step is executed in response to the receiving step.
